(19) United States
(12) Patent Application Publication
(10) Pub. No.: US 2008/0095958 A1
(43) Pub. Date: Apr. 24, 2008

(54) PROTECTIVE PANEL

(76) Inventors: Tim METZ, Bellingham, WA (US); Craig ADAMS, Bow, WA (US); Brady O'HARE, Bellingham, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/852,065

(22) Filed: Sep. 7, 2007

Related U.S. Application Data
(60) Provisional application No. 60/825,079, filed on Sep. 8, 2006.
(60) Provisional application No. 60/884,950, filed on Jan. 15, 2007.

(51) Int. Cl. B32B 5/02

(52) U.S. Cl. 428/34.1

(57) ABSTRACT

A panel member having an outer encasement where a ballistic material is positioned in a chamber region of the encasement. A closed cell rigid structural foam in one form is positioned in the chamber region and positioned adjacent to the ballistic material. With a significant ballistic threat, the ballistic material allows a projectile to pass therethrough and the closed cell rigid structural foam is configured to de-accelerate the projectile to mitigate the ballistic threat.

### RELATED APPLICATIONS

This application claims priority of U.S. Ser. No. 60/825,079 filed Sep. 8, 2006, and Ser. No. 60/884,950 filed Jan. 15, 2007.

### BACKGROUND OF THE DISCLOSURE

Certain watercraft which may engage in very adverse circumstances require certain reinforcement in the hull region to remain seaworthy. In particular, when a watercraft faces munitions fire such as fire from small arms munitions, such bullet impact can render a water vessel unseaworthy or compromise other structures (stationary and mobile). Further such projectiles can be harmful to the cargo, equipment (such as communication equipment) and passengers such as military personnel or law enforcement housed in a structure or otherwise using the panels as a ballistic shield. Therefore, a system for providing a relatively lightweight hull with proper ballistic properties to withstand projectile impact from IEDs and small arms is very desirous. Described herein is a hull having a chamber filled with a foam-like backing material which is provided for a substantially bullet-resistant watercraft and panel structures for ballistic protection on other structures.

The teaching in the art would be primarily directed to a thrust to place all of the ballistic material in the front portion, by having a portion of the ballistic material placed in the rearward region of the stacked compilation there is the effect of a greater moment of inertia and structural integrity of the unit, and greater ballistic properties. Further, the fragmentation which is induced by the urethane foam and also dispersion of the same is another benefit.

Prior art references such as U.S. Pat. No. 4,822,657 ('657) do recite having an insulation layer which is adjacent to a fabric layer which is resistant to high-impact force from projectiles. However, the '657 reference only provides a teaching for providing thermal insulation, and specifically teaches a soft backing for cushioning the stretching of the fabric layer during the impact of the panel by a projectile. As disclosed herein, there is a teaching for a closed cell rigid structural foam such as rigid polyurethane or polyisocyanurate foams. Background testing with open cell foam proved to be ineffective as compared to a closed cell rigid structural foam as described herein.

### SUMMARY OF DISCLOSURE

Disclosed herein is a structural ballistic panel member comprising a front plate having an outward surface and an inward surface. This front plate also has first and second lateral areas. A ballistic portion is part of the panel and is comprised of a ballistic fabric layer adhesively attached to the rearward surface of the front plate. There are first and second lateral wall members attached to the first and second lateral areas of the front plate. In one form these members comprise an encasement. There is a tension plate attached to the first and second lateral wall members. A chamber region is defined in part by the first and second lateral wall members and the tension plate and the ballistic portion.

A closed cell rigid structural foam is positioned within the chamber region having a foam density between 1-10 pounds per cubic foot. In one form the chamber region is substantially enclosed and the foam material is foamed in place providing a pressure in the chamber region that is greater than atmospheric pressure. The foam material can also adhere to an inner surface of the ballistic portion providing a backing to increase the ballistic properties of the ballistic portion. The front plate can be reduced to less than ¼ or ⅜ of an inch in thickness because the structural integrity of the panel provides greater rigidity. The foam region can be in one form at least 90% closed-cell rigid polyurethane and when applied to the hull portion of a boat the front plate is an outer portion of a boat hull and the foam provides for a sealed floatation even when the chamber has a projectile passing therethrough.

Of course there are many variations and details for embodiments protected in the claims recited herein.

### BRIEF DESCRIPTION OF THE DRAWINGS

FIG. 1 shows a front view of a hull portion;

FIG. 2 shows a cross-sectional view taken at line 2-2 of FIG. 1;

FIG. 3 shows the cross-sectional section of a hull with a projectile impact thereon;

FIG. 4 shows distortion of a hull by way of torsional-like forces affecting it with an exaggerated displacement of the hull;

FIG. 5 shows another embodiment where the ballistic section is comprised of one single ballistic;

FIG. 6 shows another embodiment where a rearward layer the ballistic material is positioned at the opposing region of a potential area of impact from a ballistic threat;

FIG. 7 shows the compilation and flexion where the rearward portion later provides a greater moment of inertia and is separated by the front portion by the intermediate foam backing;

FIG. 8 shows a projectile impact the front portion of the compilation;

FIG. 9 shows the dispersion of projectiles through the full region be caught at the catch layer;

FIG. 10 shows another embodiment where numerous ballistic layers interposed between foam layers;

FIG. 11 shows another embodiment of a panel with flange perimeter portions that are configured to provide an overlapping type structure for an external attachment-type panel situation;

FIG. 12 shows an example of a custom panel installation for removable and replaceable panels to be attached to a structure such as a boat.

### EMBODIMENTS OF THE PRESENT INVENTION

In general, the technology relates to ballistic plates, and more particularly ballistic plate-like structures that are used for the marine industry in watercraft, both mobile and non-mobile uses.

In general, the disclosure provides for a chamber-like region with rigid polyurethane or polyisocyanurate foam which is in the rear part of the chamber portion and which can be under some compressive force against a ballistic type material. This entire substrate is positioned within an aluminum-type chamber which is sealed or substantially sealed. The general theory of the operation is that the ballistics property of the entire unit is possibly enhanced, and the entire panel member can be lightened. Present analysis indicates that there is a load dispersion type property of this arrangement where an impact upon the ballistic material has a tendency to disperse the load throughout the rearward foam backing.

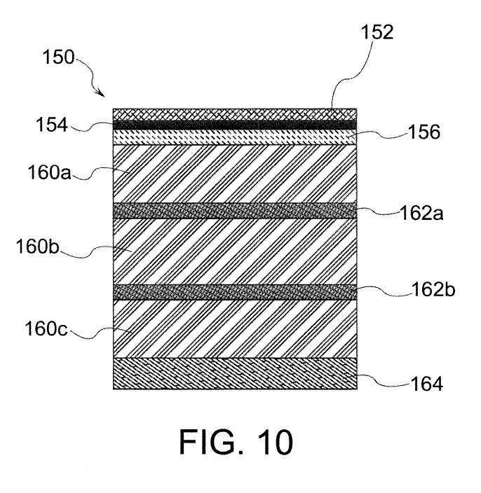

In general, this basically acts as a shock mitigation system. It should be noted that some of the criteria for to the system is to withstand 7.62×51 caliber rifle impact as well as other calibers and fragments of IEDs. Of course, the ballistics properties of the panel member can be arranged for various types of ballistic threats. For example, with a greater ballistic threat such as a 50-caliber impact, the panel structures can be enhanced with additional layers of the ballistic material 36 and increased depth of the foam backing 32, or have a multiple-layer scenario as shown in FIG. 10 and described further herein.

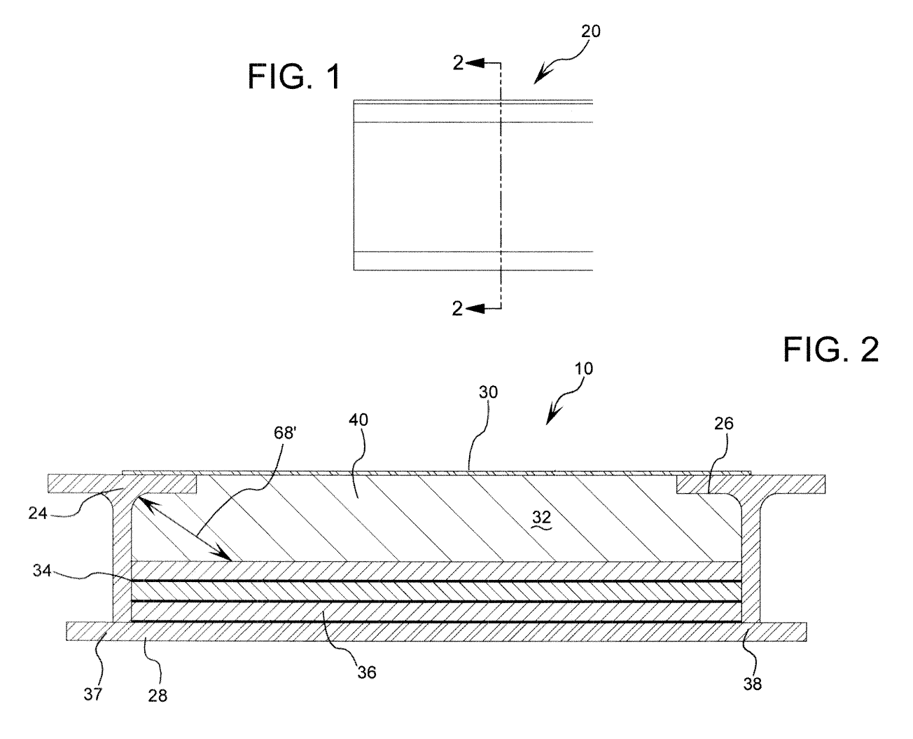

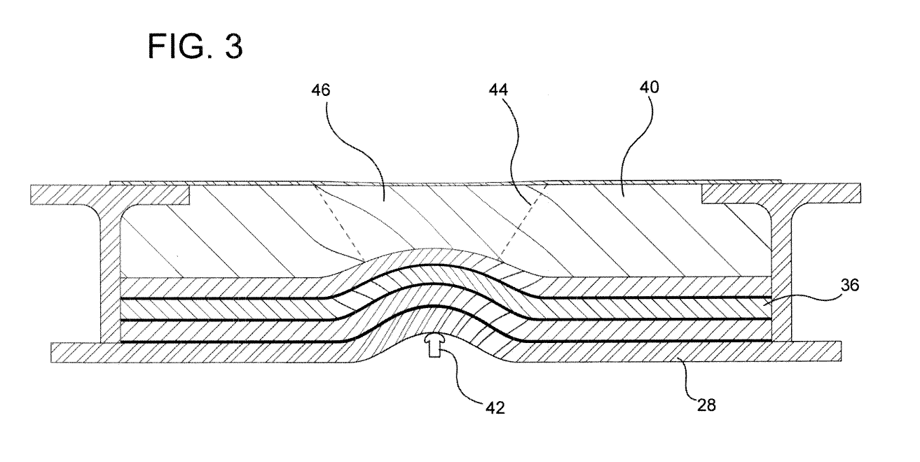

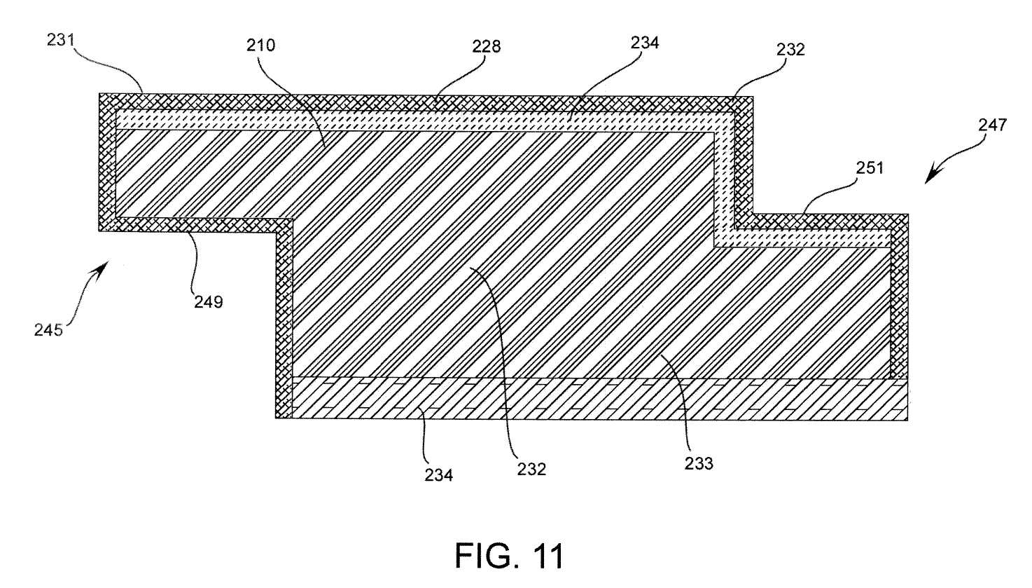

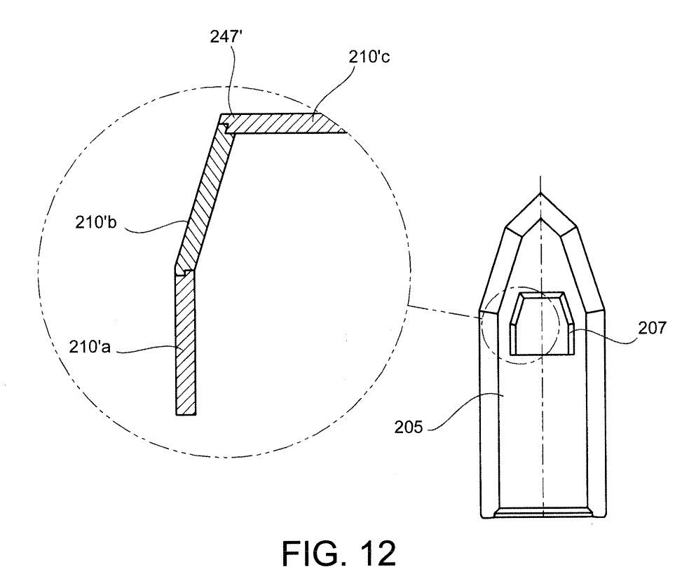

Referring to FIG. 1, there is a top view of hull portion 20 (which is part of a structure such as a boat) showing a panel member 10. Line 2-2 is a sectional view illustrating the cross-section of FIG. 2. In general, as shown in this portion, the boat hull structure 20 has a first beam member 24 and a second beam member 26. On the front portion there is a hull plate 28 and a tension plate 30 positioned on opposing inward side which is more specifically an aluminum compression plate acting in tension, as described below. The beam members 24 and 26 can be other configurations such as I-beams or other structural shapes. Therefore, the panel member 10 in one form is integral with the structure, such as a boat or other type of movable or immovable structure. Alternatively, the panel member can be similar to the configuration shown in FIGS. 11 and 12, as discussed further herein, where the panel members are fixedly and removably attached. In general, FIG. 2 shows the front plate 28 with the first lateral region 37 and a second lower region 38. The aluminum T-bars in one form are first and second lateral wall members, but of course other types of wall members could be utilized.

Therefore, it can be appreciated that the aluminum portions of the structure 24, 26, 28 and 34 form a chamber 32. Still referring to FIG. 2, there is a ballistic portion 34 which in one form can be comprised of a plurality of ballistically resilient materials or it can be a single piece of material. Interposed between the plate 28 and the material 36 is an adhesive portion which in one preferred form is reinforced with a Kevlar-like fiber. It should be noted that Kevlar (Kevlar is a trademark of the E.I. DuPont de Nemours and Company of Delaware) has a unique property of addressing heat and being relatively heat-resilient. Of course, various other ballistic materials can be stacked therebehind, such as Dyneema (Dyneema is a registered trademark of Royal DSM N.V., The Netherlands), which is 15 times stronger than Kevlar but is fairly heat sensitive (apparently breaks down at approximately 265° F.). Of course other ballistic materials could be utilized such as in the class of ultra high molecular weight polyethylene (UHMWPE), also known as high modulus polyethylene (HMPE) or high performance polyethylene (HPPE).

It should be further noted that one of the plates can be a ceramic plate which in general can be half the weight from a Dyneema plate and be thinner. In one form, the ballistic portion 30 can have a Dyneema backer to help contain the ceramic material and impacts in order to provide better ballistic properties such as sustaining multiple hits.

Now discussing the rearward portion of the chamber 32, there is a foam backer region 40 which in one form is rigid polyurethane or polyisocyanurate foam. It is believed that the foam backer has various benefits with regard to lightning the structure 20 and providing torsional resistance. An additional benefit is a spread force dispersion property where the compressed force is dispersed throughout the foam backer material and eventually dispersed to the tension plate 30.

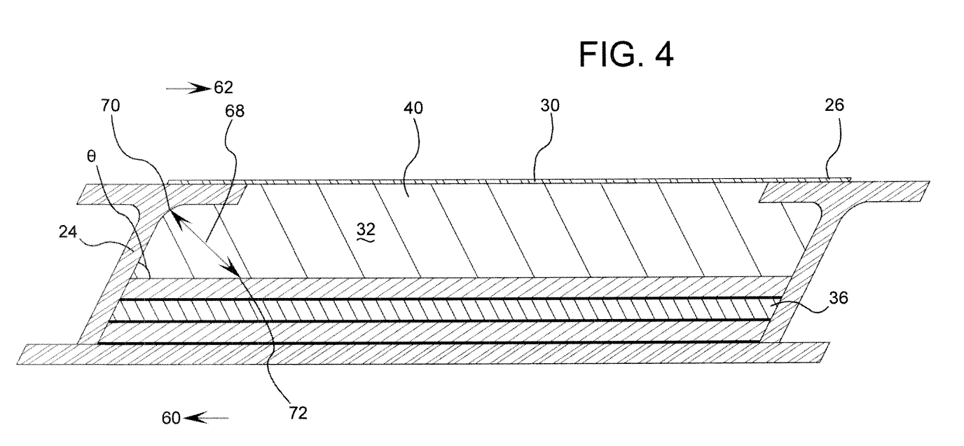

Referring now to FIG. 3, as shown in a very schematic view similar to FIG. 2, in this form, a ballistic projectile 42 has impacted the hull plate 28 (in one form) and has dispersed its kinetic energy to the ballistic plate member 36. The foam backer 40 is absorbing the impact of where the deflection is shown by the hatched line 44. The spread force dispersion properties are schematically shown by the frustoconical-like cone stress dispersion indicated at 46. It is believed that this provides a beneficial element to synergistically allow a more unified structure to handle ballistic impacts.

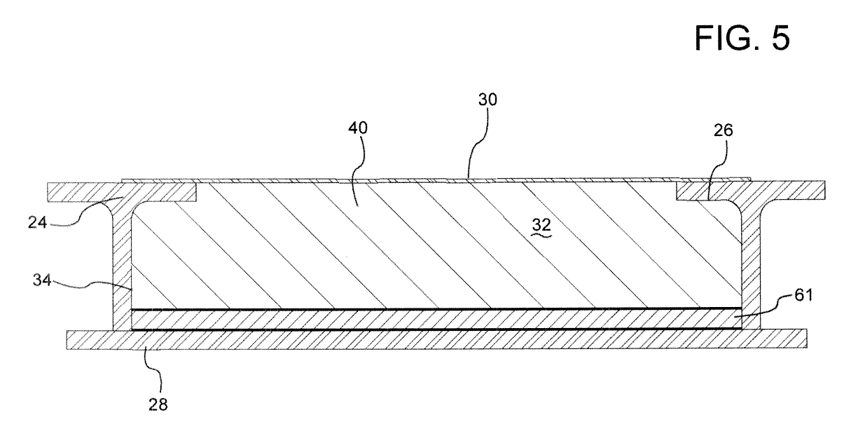

It should further be noted that as shown in FIG. 4, if there is torsion about the boat which is exaggerated in FIG. 4. However, there is a compressive force acting upon the foam backer 40 which provides resiliency to the torsion.

As shown in FIG. 4, the structure which is in one form a boat is in some form of a torsional type stress where this stress can be, for example, a twisting-like action or some shear resulting from the force vectors indicated at 60 and 62. Present analysis indicates that filling the chamber region 32 with the foam material 40 which in one form has a 90% close-cell structure helps to mechanically restrain the first and second beam members 24 and 26. It can be appreciated that the approximate distance measurement indicated at 68 from the arbitrarily chosen points 70 and 72 are in closer spatial arrangement than in an orientation such as that shown in FIG. 2. In other words, the foam 40 acts as a filler to resist such compressive-type forces which can act in a plurality of ways and the compressive forces in a multitude of fashions. Of course it should be reiterated that FIG. 4 is grossly exaggerated and illustrates the torsion/tension resistance concept.

Referring back to FIG. 2, it can be appreciated that the distance vector 68′ is longer than the approximate distance vector 68 at the approximate same reference points defining the distance. Of course this is evident as the angle alpha decreases, where there is a compression-like force which the foam cell is adapted to aid in resisting. Further, it should be noted that the foam material 40 could aid prevention of buckling of various members such as, for example, the tension plate 30 which may be thinner. Of course the concept of buckling in mechanical engineering disciplines can be mitigated by having a material such as foam backer portion 40.

Therefore, it can be appreciated that the compression plate 30, along with the ballistic plate(s) 36 in conjunction with the foam material 40 provides an assembly creating a composite-like structure to have an increased structural resistance property, shock dissipation of projectiles imparting kinetic energy thereon to add to the overall rigidity and strength of a boat hull.

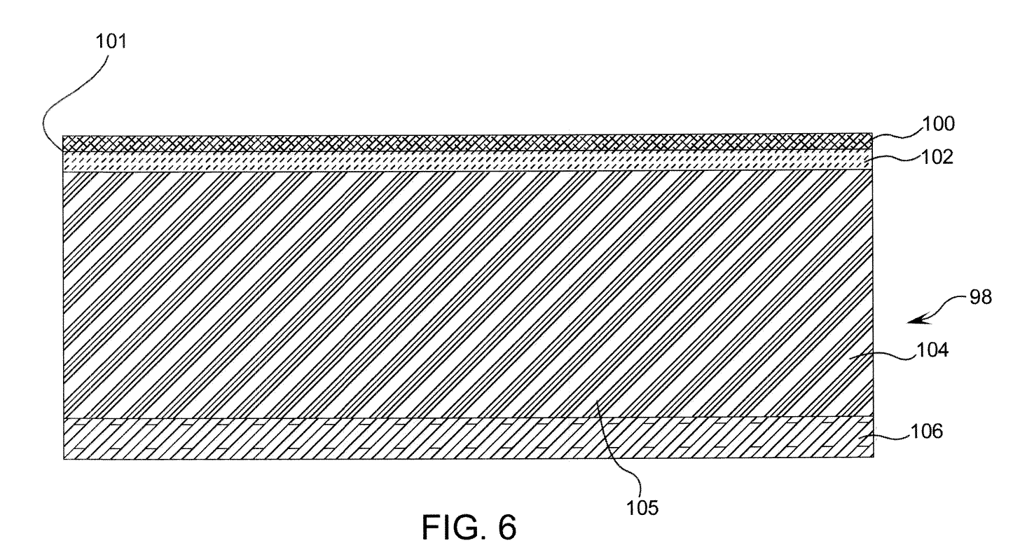

As shown in FIG. 5, there is another version where the ballistic region in this embodiment is comprised of a single contiguous sheet of material indicated at 61. In general, the ballistic region can be comprised of one or more discrete sheets or a compilation of multiple sheets adhesively attached to one another which can have in one form an adhesive interposed therebetween. Further, as described above, a layering such as a Kevlar layering for heat dispersion mixed with an adhesive can also be utilized between one or multiple layers of the ballistic materials 61.

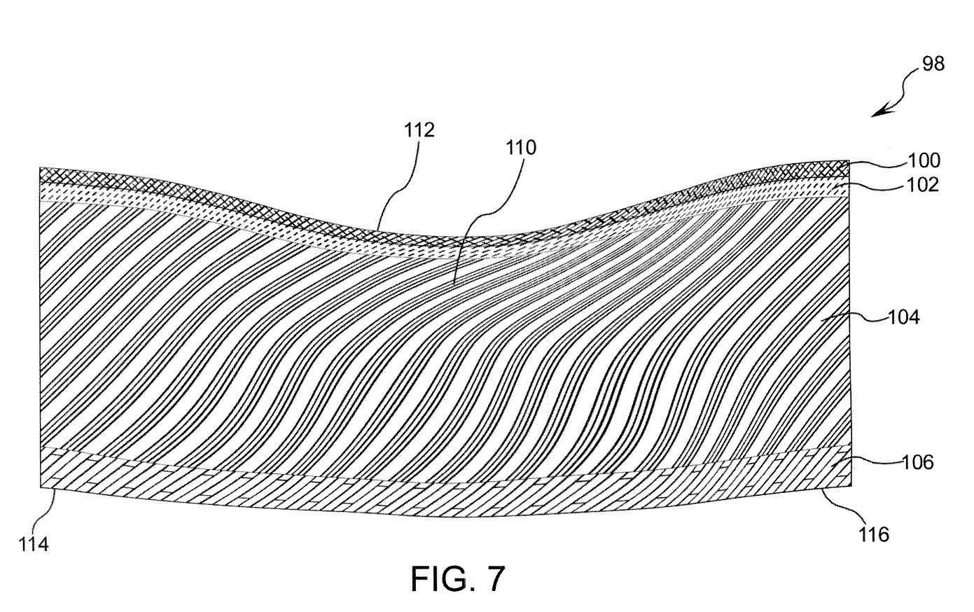

In FIG. 6, there is a second embodiment of a ballistic compilation 98. In general, the compilation includes the layer 100 which can be an exterior layer such as aluminum, wood siding, or any other kind of veneer or layer which can be exposed to the elements, or further any aesthetically-pleasing type of surface. Positioned behind the layer 100 is an outer ballistic layer 102, which can be comprised of a variety of materials as mentioned above. The layer 100 can be applied to the ballistic layer 102 with and adhesive applied at 101 in FIG. 6 which can be similar to the layer 154 in FIG. 10 described further herein. The ballistic layer 102 can be comprised of a ceramic-type material, similar to layer 36 as described above. Positioned behind the layer is the foam backing region 104, which in one form comprises a rigid polyurethane or polyisocyanurate foam. Such foam can, in one form, have a minimum density of 2 pounds per cubic foot, and this value can be higher in some applications. The density of the urethane foam will vary depending upon the ballistic threat. This range can generally be between approximately 1-10 pounds per cubic foot, with 2-6 as a preferred range. In general, present analysis indicates that the more air bubbles and smaller the bubbles are positioned within the layer 104, the better the effect is of tumbling any projectiles which break through the layer 102.

It should be noted that the foam backing layer 104 provides the shot-mitigating value with the structure, and further, during construction of the ballistic compilation 98. When the foam backing layer is curing it will adhere to the layers 102 and 106 and some forms of construction of the assembly, it is created under pressure to bind to these adjacent layers.

In one form the backing can increase from up to ½ of an inch to a larger distance such as 12 inches, in one form. Once the front layer of ballistic material has operated to rotate the bullet, in the foam can take action to slow this projectile down. In one form, ballistics material can be removed from the front strike plate material such as aluminum or other type of metal. There could be a sufficient amount material to rotate about a lateral axis of the bullet to allow the foam to take its functional action thereafter of slowing the bullet down by way of its fluid-like resistance as the bullet passes therethrough.

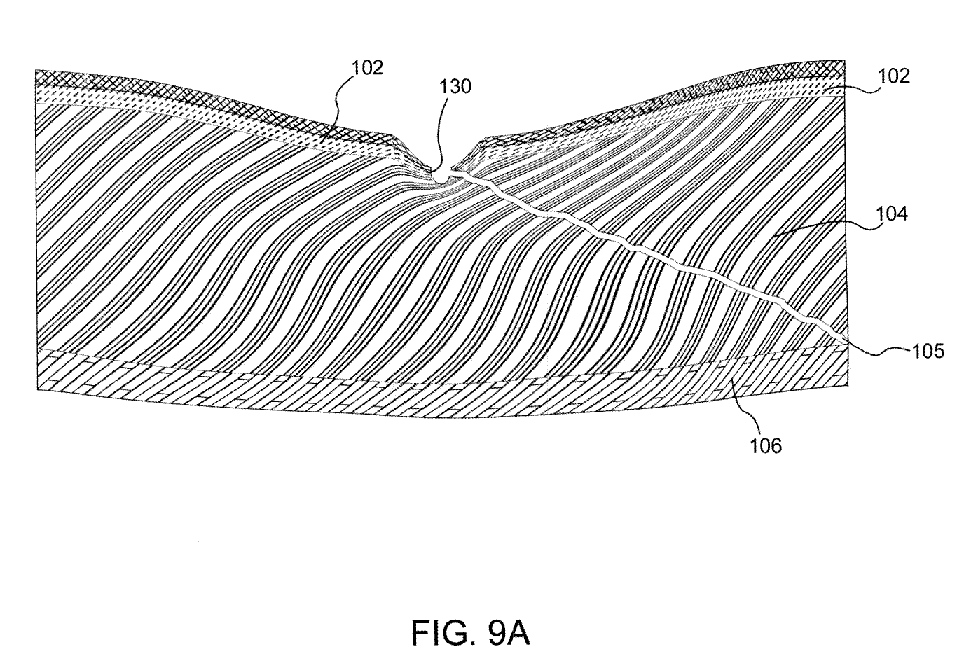

Finally, the layer 106 can be of a flexible cloth-like material, such as Dyneema or a backer such as a thin piece of aluminum or a combination of a ballistic fabric with a metal. Such a combination can be adhesively combined. In general, the layer 106 can act as a “catchers mitt layer” to catch various projectiles or pieces of the projectile that may penetrate through the layer 104 as described herein with reference to FIG. 9. Further, this catch layer 106 that can be positioned adjacent to material, such as doors on vehicles or on buildings to create, for example, a safe house.

The tension plate/catcher layer 106 can be somewhat thinner than if it were the only ballistic material utilized. The projectile has already passed through the layers 100, 102 and 104 prior to engaging the layer 106. As previously noted, present analysis indicates that the projectile may be fragmented, and of course with lower velocity prior to striking the Dyneema (in one form) defined as the catch layer 106.

One advantage of the material is as the bullet impacts the front region the combination of components has a propensity for the bullet to rotate. This property is useful insofar that instead of the cylindrical cross-sectional profile being exposed, when the bullet rotates there is a much greater exposed surface area since the majority of all ballistic projectiles are greater in the longitudinal length than in their cross-sectional area. However when the round rotates the greater amount of surface area significantly aids in the slowing down of the bullet, and of course in some forms breaking the projectile into pieces which in turn causes greater surface area to slow the projectile and absorb its energy.

One unexpected result is shown similar to FIG. 9A where in testing a bullet struck a test plate at an oblique trajectory where exited at a side portion of the test plate. The test plate was approximately a 12×12 inch sample with the thickness of approximately 1 inch of foam and 15 layers of ballistic material (in this case Spectra) connected by an adhesive with a ⅛ inch thickness aluminum plate backing. The shot was taken at 150 of obliquity and took a lateral course with respect to the normal angle from the front surface of the plate, and then exited at a corner region of the plate. For this particular test a 7.62×54R bullet with a bullet weight of 150.2 grains traveling at 2516 feet per second was used and exited in a corner region which as shown in FIG. 9A would be similar to exiting in the region indicated at 105. Because FIG. 9 is not to scale, the trajectory is substantially altered as compared to the initial impact angle with respect to the ballistic plate.

With regard to manufacturing, a foam area 98 as shown in FIG. 6 can be made in a mold to make a packed section to control the density of the urethane foam. As described further herein, in one form the foam is foamed in place within the chamber region of the panel. In this form, the two-part chemical mixture which is conventional in forming polyurethane foam is placed within the chamber and the expansion of the foam fills the chamber region, and in addition to the side lateral plates, lower and upper plates are positioned to make a substantially sealed chamber.

An adhesive can be interposed between the ballistic material on the front panels as well as in between layers of ballistic material. Further, the adhesive can be positioned between the foam and the rearward layer of the ballistic material or could be foamed in place where the chamber is set and the polyurethane foam has two compounds that are placed therein to expand the inner chamber. The adhesive can also be positioned between the back plate and the urethane foam. When the foam is set in place in the channel of the panel, the foam itself can function as an adhesive.

Further, foam adhesive between the rear portion of the foam and the back plate could have the effect of making a laminated-type beam for greater strength and rigidity of the entire panel structure.

It should be noted, as far as the manufacturing process, when inserting the foam in place, the polymer adhesive is in one form heated between 90 to 110° F. Further, the surrounding substrate material can be the approximate temperature to mitigate the amount of heat transfer therebetween. In one form, the foam expands about 3 pounds per square inch. For example, in one form the member 10 is an architectural panel. However, when the unit expands there can be a slight outward bowing action of the tension plate and an almost pre-tension-like effect. Further, the sum of the tension vectors when an impact strikes the front portion of the ballistic plates, provides pressure in the chamber and tension upon the tension plate. Further, this bowing of the tension plate can aid in providing for increased pressure above atmospheric within the chamber.

Now referring back to FIG. 6-9, the layer 106 stores little energy and has a very high modulus elasticity and resists expanding, if the projectile breaks through the ballistic layer 102, any kind of a sonic-like wave or inclination of separating the foam outwardly will be greatly resisted by the chemically bonded region 105 between the foam backing 104 and the catch layer 106.

As noted above, having additional closed-cells the greater amount of cells and smaller amount of cells has an adverse effect upon the projectile maintaining its speed as it passes therethrough. In other words, smaller bubbles essentially create more drag of any projectile attempting to pass therethrough. The structural closed cell foam provides a spacing between the layers 102 and 106, and further provides a chemical locking between these layers.

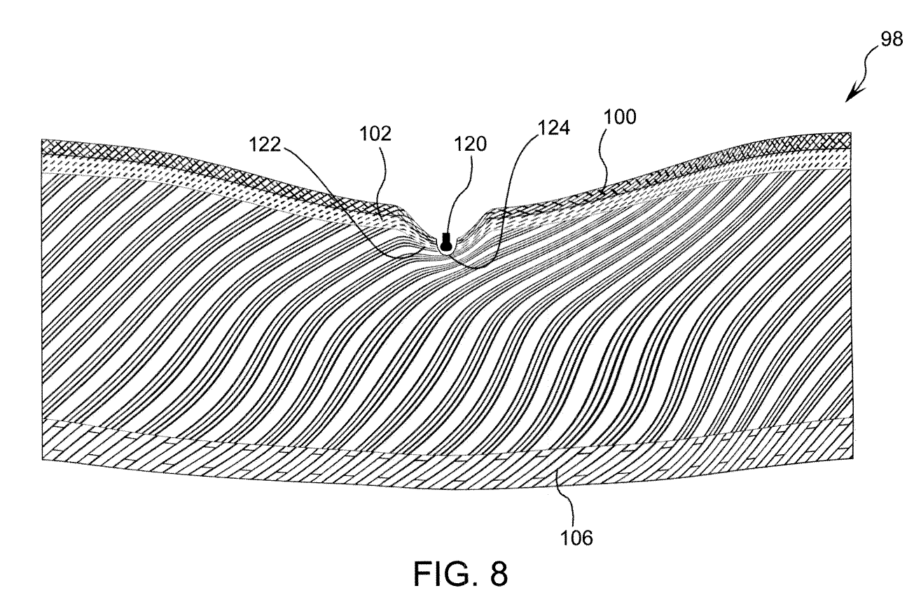

Now specifically referring to FIG. 7, there is shown the ballistic compilation panel 98 where it can be appreciated that the catching layer 106 having a high modulus of elasticity resists stretching, and the upper portion 110 of the foam layer 104 is in slight compression and is resisting compressive force acting thereon. The deflection acting upon the ballistic compilation 98 can be of a variety of external forces. For example, the central region 112 could have a force acting thereupon towards the center core region of the compilation where the outer portions 114 and 116 are imposing a force upon the structure. Therefore, the layer 106 will be in tension, and as illustrated in a slightly exaggerated model in FIG. 7, the amount of tensile deflection is minimal with this rear layer in place.

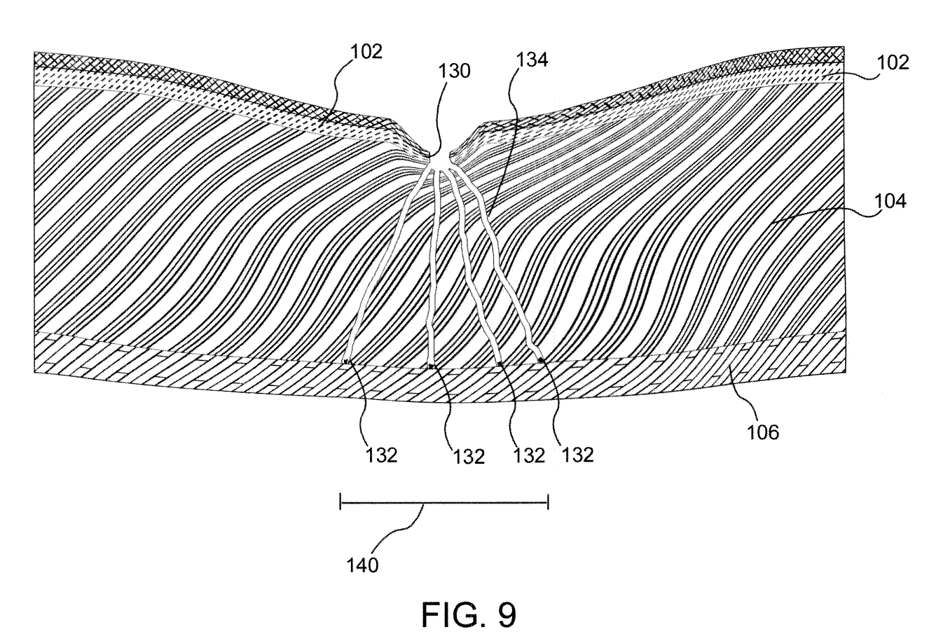

Now referring to FIG. 8, there is shown a deflection upon the ballistic compilation 98 where a projectile 120 has struck the outer portion of the compilation. In one form, the layer 100 has minimal ballistic properties but provides a veneer like covering for the compilation. However, the ballistic layer 102 having the structural foam indicated at the region 122 provides immediate support behind the impact zone 124 to strengthen and provide greater ballistic resistance for the layer 102. Further, as noted above, because of the beam properties of the compilation 98 such as that shown in FIG. 7, the overall structure will better resist deflection at this point because of the rear ballistic layer 106.

Referring to FIG. 9, there is shown another aspect of the present embodiments, where present analysis indicates that if the projectile were to break through an opening indicated at 130, the ballistic layer 102 can create fragments and fragmentize the projectile such that shown in FIG. 8 as 120. FIG. 9 shows a plurality of projectiles 132 which are shown by way of example where the projectiles have expanded through the cone-like path 134 through the foam layer 104. Present analysis indicates that by initially fragmenting a projectile through the ballistic layer 102, the smaller diameter projectiles 132 now have a greater surface-area-to-mass ratio, thereby increasing drag as they pass through the layer 104. Further, the natural tendency of dispersion, such as a spreading shotgun blast, disperses the projectile threat in the lateral direction so the projectiles are not as focused, as indicated by the impact width 140 shown in FIG. 9. It should be noted that the scale in the above noted figures is not that as shown with regard to the layer 106 where this layer can be a flexible woven like structure/material made from high tensile yield material fibers such as Kevlar or Dyneema.

As described above, the rearward ballistic layer 116 in this form can act as a catcher's mitt to catch the foam layer 104, and there is a chemical bond between the foam layer 114 and the adjacent layers 106 and 102.

Now referring to FIG. 10, there is shown another composition 150, where in this form, there can be an outer layer 152, which can be a veneer material such as aluminum, wood or other type of outer covering. Behind the aluminum can be the layer 154 which in one form is a fiber-impregnated adhesive. A commercially available adhesive impregnated with a fiber such as Kevlar fiber, provides an increased bond shear tensile strength, and also retards heat gain from external sources, such as welding, that could degenerate the panel. Present analysis indicates that the high insulation value of this layer 154 inhibits the heat transfer therethrough. Present testing indicates a temperature drop from 962° F. to 103° F. on the opposing side of the weld sight. In general, some ballistic materials cannot become too hot before the matrix-like structure breaks down and loses the ballistic properties.

The next layer 156 is a ballistic layer, which can be made of a variety of materials, such as ceramic, Kevlar, Dyneema, Spectra, or other materials resistant to a ballistic threat. The layers 160a, 160b and 160c are urethane foam layers which provide shock mitigation and projectile fragmentation, as well as a greater modulus elasticity of the entire structure, as described in detail above. Interposed between the layers are internal ballistic fabric layers 162a and 162b. These intermediate layers provide additional protection and can assist in catching projectiles passing through the urethane foam layers. The final layer 164 is similar to the layer 106 in FIGS. 6-9 and is positioned in the rearward portion of the compilation 150.

The adhesive, in one form, is commercially available and is mixed with commercially available fiber, which results in an adhesive having a shear strength greater than 1700 psi, and has a thermal reduction property. As noted above, ballistic materials can have difficulty maintaining their properties with higher temperatures. Many conventional binders degrade around 265° F. Therefore, a relatively thin layer of adhesive tends to prevent the heat transfer to the interior portion of the panel. Therefore, this adhesive layer prevents degradation of the binder material of the adhesive. Without the fiber there is still a reduction of heat; however, one preferred form has fiber therein. In this testing the temperature is next to the tig weld area on the opposing side.

The adhesive in one form is a one-part moisture cured urethane adhesive, but epoxy and other types of adhesives could be utilized as well. The addition of the fiber enhances bonding strength and also dissipates heat. In one form, the fiber can be Kevlar, but of course other types of fibers can be utilized. When mixing the Kevlar fiber with the adhesive, a matrix like effect can occur and cross-link the fiber materials adjacent to one another. One unexpected result is the drop-in temperature on an opposing side of a front panel which can be welded.

With a larger round there may be a sandwich-like embodiment as shown in FIG. 10. For example, there can be 15 plies of Spectra followed by 1 inch of foam and then 10 plies of TBS with 1-6 inches of foam. This composition has the effect of breaking a very hot round such as depleted uranium round from a 50 caliber where the initial layers change the trajectory of the round and the layered foam and ballistic layer combination can have the effect of slowing the projectile in stages and diverting its path. It should be further noted that there is the unexpected effect of not allowing the heat transfer to the interior ballistic layers. Therefore, certain types of threats, such as heat threats from flamethrowers or other types of inflammatory substances, such as Molotov cocktails or napalm, can be mitigated by the nature of the adhesive which has a propensity for not allowing heat to pass into the panel.

As shown in FIG. 11, there is another form of a panel member 210. In this form, there is a ballistic portion 234 which as noted above can be layers of fabric ballistic material joined by an adhesive. The front plate 228 can in one form engage to the first and second lateral regions 231 and 233 and further engage around the overlap interface regions 245 and 247. In a similar manner as shown above, the interior chamber region 232 is filled with a foam material indicated at 233. The back plate 234 can be of a variety of structures as described above, but in one form can be a metallic structure such as a thin layer of aluminum. In one form, the plates 228 and 234 can be for example ⅛ inch thick aluminum. It has been found that using the ballistic layer 234, the aluminum layer can be thinner from say 3/16 of an inch in thickness, reducing the gross weight of the panel while increasing the ballistic property thereof.

In this panel form as shown in FIG. 11, the overlap interface regions 245 and 247 in general comprise a notched-out type layer where the surface 249 is configured to attach to an adjacent surface 251 of an adjacent panel. Of course, openings can be provided to allow fasteners to pass therethrough, such as bolts or the like.

Now referring to FIG. 12, there can be seen various ballistic panels 210a′-210c′. In this form, the boat 205 is shown and in one form can have the internal panels in the hull region and on the gunnels in the manner as described above with reference to FIG. 2. However, for example, the cabin region 207 can have ballistic protection in the manner as shown in the call out portion of FIG. 12. In one form, the various panels are shown schematically and can, for example, be attached to an outer region of a cabin like structure. Of course, the various shapes and interface portions 247′ can be of a proprietary type design to have the first panel members fit together.

It should be reiterated that the foam is preferred to be closed cell rigid structural foam. Reactive foams, such as the rigid polyurethane-type foams, are one preferred form as well as the rigid polyisocyanurate classification of foams. The closed cell structure has desirable ballistic properties so as not to cushion the stretching of the fabric layer but rather provide structural support thereof and to provide a medium to retard the trajectory of a projectile. The structural foam in one form is desirable to be at a minimum of 92% closed-cell structure. Of course in a broader range, this can vary by up to 8%. It has been found that ballistic protection of a level III ballistic threat can be obtained with as little as 1.8 pounds of ballistic material per square foot. In other forms, the material is increased to 4 pounds per square foot, and in the instance of a greater ballistic threat, 6 pounds per square foot or greater. However, it has been found that the closed cell rigid structural foam has a propensity to synergistically cooperate with the ballistic layers to defeat a high velocity rifle round.

Whereas the prior art devices attempt to defeat the round right at the ballistic fabric layer, as described above, and as schematically shown in for example FIG. 9, testing has demonstrated that the closed cell rigid structural foam has an unexpected propensity for defeating a ballistic threat which breaks through the ballistic fabric layer, such as Keviar, Dyneema or Spectra or other ballistic materials such as in the class of UHMWPEs and other ballistic materials. In no way is the ballistic material confined to the above-mentioned materials.

While the present disclosure is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicant's general concept.

I therefore claim:

1. A structural ballistic panel member comprising:
a) a front plate having an outward surface and an inward surface, the front plate further having first and second lateral areas,
b) a ballistic portion comprised of a ballistic fabric layer adhesively attached to the rearward surface of the front plate,
c) first and second lateral wall members attached to the first and second lateral areas of the front plate,
d) a tension plate attached to the first and second lateral wall members,
e) a chamber region defined in part by the first and second lateral wall members, the tension plate and the ballistic portion,
f) a closed cell rigid structural foam positioned within the chamber region having a foam density between 1-10 pounds per cubic foot.

2. The structural ballistic panel member as recited in claim 1 where the chamber region is substantially enclosed and the foam material is foamed in place providing a pressure in the chamber region that is greater than atmospheric pressure.

3. The structural ballistic panel member as claim 2 where the foam material adheres to an inner surface of the ballistic portion providing a backing to increase the ballistic properties of the ballistic portion.

4. The structural ballistic panel member as recited in claim 1 where the front plate is a metallic plate.

5. The structural ballistic panel member as recited in claim 4 where the front plate is an aluminum plate less than ¼ of an inch in thickness.

6. The structural ballistic panel member as recited in claim 4 where the front plate is an aluminum plate less than ⅜ of an inch in thickness.

7. The structural ballistic panel member as recited in claim 1 where the ballistic portion is comprised of at least 5 layers of ballistic fabric connected by an adhesive.

8. The structural ballistic panel member as recited in claim 1 with the foam material is in direct contact with an inner surface of the first and second lateral wall members.

9. The structural ballistic panel member as recited in claim 1 where the ballistic portion is comprised of at least 15 layers of ballistic fabric connected by an adhesive.

10. The structural ballistic panel member as recited in claim 8 where the foam material is in direct contact with the tension plate.

11. The structural ballistic panel member as recited in claim 1 where the first and second lateral regions of the front plate define overlapping interface regions that are operatively configured to connect to an adjacent overlapping interface region of an adjacent structural ballistic panel member.

12. The structural ballistic panel member as recited in claim 1 where the structural ballistic panel member is positioned within the hull portion of a boat and the front plate is an outer portion of a boat hull.

13. The structural ballistic panel member as recited in claim 1 where the foam region is at least a 90% closed-cell rigid polyurethane or polyisocyanurate foam.

14. The protective panel as recited in claim 13 where the ballistic material is adhered to the inner surface of the front panel by way of an adhesive which is mixed with a fiber.

15. The protective panel as recited in claim 15 where the fiber in the adhesive has the thermal property of reducing heat transfer to the ballistic material more so than if the fiber was not used.

16. The structural ballistic panel member as recited in claim 13 where the foam layer is operatively configured to receive a projectile that passes through the ballistic portion.

17. The structural ballistic panel member as recited in claim 16 where the foam layer is operatively configured to reduce the velocity of the projectile and divert the projectile's initial course before impacting the structural ballistic panel.

18. A projectile stopping system configured to stop the level 3 ballistic threat from a projectile, the projectile stopping system comprising:
a) an encasement having a front wall and a rear wall and a first and second lateral walls,
b) a ballistic resistant material positioned adjacent to the front wall and adhered thereto,
c) a closed cell rigid structural foam positioned within the chamber region which is foamed in place, creating a slight positive pressure in the chamber region above atmospheric pressure,
d) whereas the ballistic resistant material is properly configured to allow a level 3 ballistic threat to pass therethrough and the closed cell rigid structural foam is configured to de-accelerate the projectile sufficiently prior to the projectile exiting the rear wall of the encasement.

19. The projectile stopping system as recited in claim 18 where the rear wall is a sheet of ballistic material.

20. The projectile stopping system as recited in claim 19 where the ballistic material is either Kevlar, Spectra or Dyneema.

21. The projectile stopping system as recited in claim 18 where the closed cell rigid structural foam is at least 92% closed cell.

22. A protective panel operatively configured to stop at least a level III ballistic threat from a projectile, the protective panel comprising:
a) a substantially enclosed encasement and a front wall and a rear wall and a perimeter wall,
b) a ballistic resistant material positioned adjacent to the front wall and a closed cell foam foamed in place and adhered to a rearward surface of the ballistic resistant material,
c) whereas the closed cell foam is configured to de-accelerate a projectile sufficiently prior to the projectile passing through the rear wall of the substantially enclosed encasement and the ballistic resistant material is configured to allow a ballistic threat which is greater than level III to pass therethrough to enter the closed cell foam.

23. The protective panel as recited in claim 22 where the closed cell foam is at least 1 inch in thickness behind the ballistic resistant material.

24. The protective panel as recited in claim 22 where the protective panel is comprised of aluminum.

25. The protective panel as recited in claim 22 where a second layer of ballistic resistant material is positioned in the foam.

26. The protective panel as recited in claim 23 where the closed cell foam is no more than 6 inches in thickness behind the ballistic resistant material.

27. The protective panel as recited in claim 26 where the protective panel is a portion of a hull of a boat.

28. The protective panel as recited in claim 22 where the ballistic material is adhered to the inner surface of the front panel by way of an adhesive which is mixed with a fiber.

29. The protective panel as recited in claim 28 where the fiber in the adhesive has the thermal property of reducing heat transfer to the ballistic material more so than if the fiber was not used.

30. The protective panel as recited in claim 29 where the fiber in the adhesive is Kevlar.
